(19) United States
(12) Patent Application Publication
(10) Pub. No.: US 2021/0309406 A1
(43) Pub. Date: Oct. 7, 2021

(54) Label Wrapper With Soft-Touch Jaws

(71) Applicant: Brady Worldwide, Inc., Milwaukee, WI (US)

(72) Inventors: Brent Bandholz, Hubertus, WI (US); Alan J. Suva, Menomonee Falls, WI (US)

(21) Appl. No.: 16/839,895

(22) Filed: Apr. 3, 2020

(51) Int. Cl. B65C 9/06; B65C 3/02

(52) U.S. Cl. CPC B65C 9/06; B65C 3/02

(57) ABSTRACT

Systems and methods include a label wrapper assembly that can retain elongate objects while adhering a label thereto. The assembly can include a wrapping subassembly with a wrapping subassembly axis that can be configured to apply a label to an elongate object by rotating around the elongate object about the wrapping subassembly axis. A set of clamp assemblies can be axially spaced apart along the wrapping subassembly axis on both sides of the wrapping subassembly. Each of the clamp assemblies can have a set of clamp members slidably movable relative to each other between an open position and a clamping position, and the clamp members can provide a clamping force in the clamping position. Each of the clamp members can have a retention element to retain the elongate object therebetween when in the clamping position, and the retention elements can be elastomeric.

### CROSS-REFERENCE TO RELATED APPLICATION

Not applicable.

### FIELD OF INVENTION

This disclosure relates to label wrappers, and more particularly to a label wrapper with clamping assemblies that can retain an elongated object.

### BACKGROUND

Labels are often applied to elongate objects, such as wire, to provide information about the wire. One such approach is to apply a label by hand. This approach can prove difficult to do in an accurate, consistent, and timely manner and is labor intensive. It can also be difficult to consistently place the labels in such a way that the labels are square and aligned on the wire and to properly and evenly adhere the label to the surface of the wire.

Accordingly, mechanical label applicators are available that assist in the application of preprinted labels to elongate objects such as wire. These applicators are typically designed to be used with sheathed objects, such as wire, in which the sheath provides a protective and gripable surface to which the label is also be attached.

### SUMMARY

Such conventional mechanical label applicators for sheathed objects like wire rely in part on the ability for the wire to be clamped at two locations to create a relatively taut section. About this taut section, a sub-assembly of the label applicator is operated and rotated to apply the label.

However, this clamping of the wire in the first instance can potentially mar or damage the surface of the wire or object. For example, in particularly small diameter wires, the sheathing may be relatively thin and even moderate clamping forces may deform the sheathing. Moreover, in certain types of objects, like fiber optic cables, a high clamping force can cause internal damage, which can have a detrimental effect to performance or mechanical integrity, for example, signal degradation.

Provided herein is a novel structure for a label wrapper assembly with soft-touch jaws that addresses many of the aforementioned issues and provides an improved mode of clamping for a label wrapper assembly. Uniquely, such a label wrapper assembly may include a set of clamp members including retention elements, which may assist with gripping and retaining an elongate object without damaging its surface or internal structure. The retention elements can absorb at least a portion of the clamping force applied to the elongate object and deform rather than the object itself and thereby can reduce the likelihood of marring or other forms of damage to the elongate object during the label application process.

According to one aspect, a label wrapper assembly configured to adhere a label to an elongate object is provided. The label wrapper assembly includes a wrapping subassembly with a wrapping subassembly axis. When applying a label to the elongate object, the wrapping subassembly rotates about the wrapping subassembly axis and around the elongate object. The label wrapper assembly also includes a set of clamp assemblies axially spaced apart along the wrapping subassembly axis on both sides of the wrapping subassembly. Each of the clamp assemblies has a set of clamp members slidably movable relative to each other between an open position and a clamping position. The clamp members provide a clamping force in the clamped position (which may be created by for example a biasing element such as for example, a spring). Each of the clamp members has a retention element with a notch and the retention elements retain the elongate object therebetween when in the clamping position. The retention elements are elastomeric.

In some forms, the notches can have a V-shape profile.

In some forms, the retention elements can comprise polyurethane.

In some forms, the retention elements can be overmolded portions of the clamp members. In some forms, the retention elements can be inserts coupled to the clamp members.

In some forms, the elongate object to be retained within the label wrapper assembly has a diameter in the range of about 0.04 inch to about 0.25 inch.

In some forms, each clamp assembly can be configured to apply a clamping force of about 2.5 lbs (11.12N) or less to the elongate object when in the clamping position.

In some forms, the set of clamp members can include a pair of lower clamp members coupled together and an upper clamp member positioned between the pair of lower clamp members.

In some forms, the clamp assemblies can be operated between the open position and the clamping position by a rack and pinion arrangement. At least one of the pair of lower clamp members has a lower clamp member rack, the upper clamp member has an upper clamp member rack, and a pinion is operably engaged with both the lower clamp member rack and the upper clamp member rack to drive the pair of lower clamp members and the upper clamp member in opposite directions.

In some forms, the label wrapper assembly can further include a structural member with bearings and the clamp members can have slots in which the bearings are received. The clamp members can then move linearly relative to the wrapping subassembly along the bearings.

In some forms, a method of retaining an elongate object within the label wrapper assembly can be provided. The method can include opening the set of clamping assemblies and clamping the elongate object between opposing retention elements of the clamping assemblies. This clamping force may be applied by a biasing member, for example, a coil spring.

In some forms, the clamping force can be in the range of about 1.5 lbs (6.67N to about 2.5 lbs (11.12N).

In some forms the retention elements can comprise polyurethane. The retention elements can be, for example, overmolded portions of the set of clamp members. The retention elements can also be inserts coupled to the clamp members.

In some forms, the retention elements can have notches with a V-shape profile.

In some forms, the method can further include tensioning the elongate object within the set of clamping assemblies. The method can also further include a step of aligning the elongate object along the wrapping subassembly axis.

In some forms, at least some of the clamping force is absorbed by the retention elements through deformation of those retention elements when contacting the elongate member.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is a front perspective view of a label wrapper mechanism in which an exemplary embodiment of a label wrapper assembly is provided.

FIG. 2 is a front perspective view of an example embodiment of a portion of label wrapper assembly in an open position.

FIG. 3 is a front perspective view of the label wrapper assembly of FIG. 2 in a clamping position.

FIG. 4 is right side elevation view of an example clamp assembly in an open position.

FIG. 5 is a left side elevation view of the clamp assembly of FIG. 4.

FIG. 6 is an exploded perspective view of the clamp assembly of FIG. 4.

### DETAILED DESCRIPTION

Before any aspect of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Terms indicating relative position such as “above,” “below,” “upper,” “lower,” “rear,” “front,” and so forth are used for purposes of illustration only, unless otherwise noted and are made with reference to the orientation of the drawings. It should be understood that these terms are not generally meant to indicate a preferred orientation when such an orientation is not inherently or explicitly required.

Reference will be made throughout to applications of embodiments disclosed herein that adhere a label to a wire. Such references are for purposes of illustration and are not intended to limit the claimed invention to such applications. Rather, any elongate object may be used in conjunction with any label applicator described herein. Further it is contemplated that elongate object may refer to bundles of such objects as well.

Conventional approaches to label application such as those described above have disadvantages, and the application of an adhesive label onto an elongate object having a relatively small diameter, such as a fiber optic cable or other small diameter wire with a diameter in a range of about 0.04 inch to about 0.25 inch, presents a host of additional problems. For example, when applying a label to a fiber optic cable, the label can stick to the label applicator as it is pressed against the cable or the label may be misaligned and cause spiraling or wrinkling of the label or creating bubbles within the label. Furthermore, it is difficult to sufficiently clamp a small diameter cable to allow a uniform application of a label without marring the cable or inflicting other types of damage.

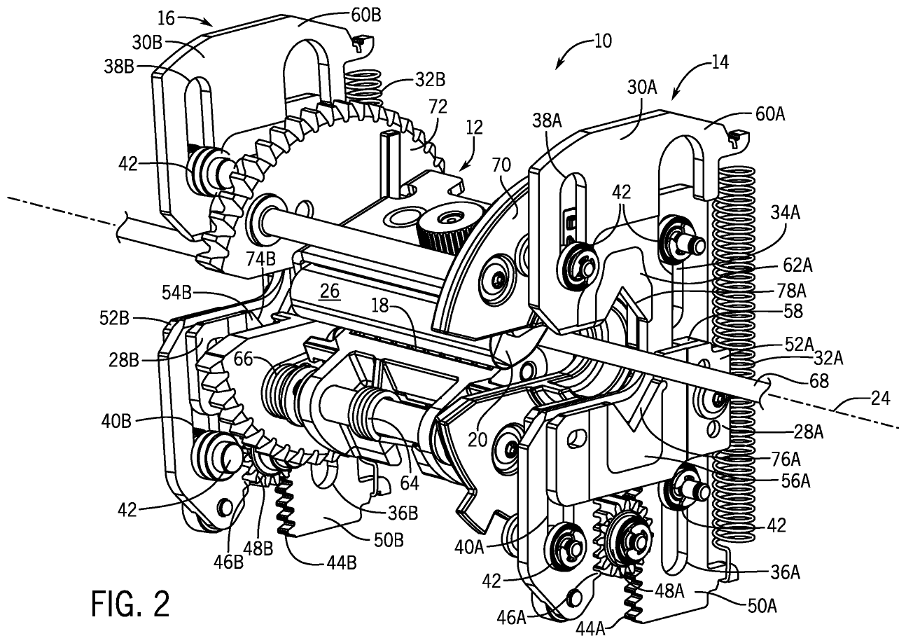

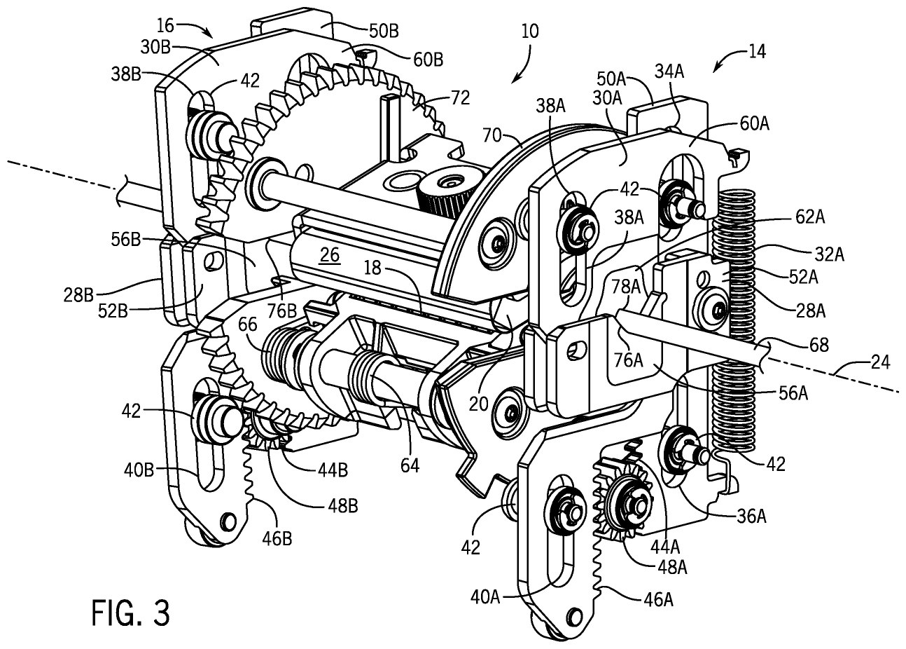

Generally, the present disclosure provides a label wrapper assembly that can be configured to adhere a label to an elongate object. In some embodiments, the label wrapper assembly can be configured to clamp the elongate object with retention elements comprising an elastomeric material. In some embodiments, the use of retention elements comprising elastomeric material can decrease the amount of clamping force required to retain the elongate object within the label wrapper assembly at least in part to an increase in the coefficient of friction between the elongate object and the elastomeric material over that of, for example, steel. In some embodiments, the clamping of the elongate object can be performed by a set of clamping assemblies on either side of a wrapping subassembly. In some embodiments, the clamping assemblies can include clamp members slidably coupled and configured to move between an open position (see FIG. 2) and a clamping position (see FIG. 3). In some embodiments, the clamp members can be biased in the clamping position. In some embodiments, other configurations are possible. For example, certain features and combinations of features that are presented with respect to particular embodiments in the discussion above can be utilized in other embodiments and in other combinations, as appropriate.

This application discloses a number of improvements over and enhancements to the label applicators disclosed in the inventor's U.S. Pat. Nos. 6,875,304 and 7,178,572, which are incorporated herein by this reference in their entirety for all purposes.

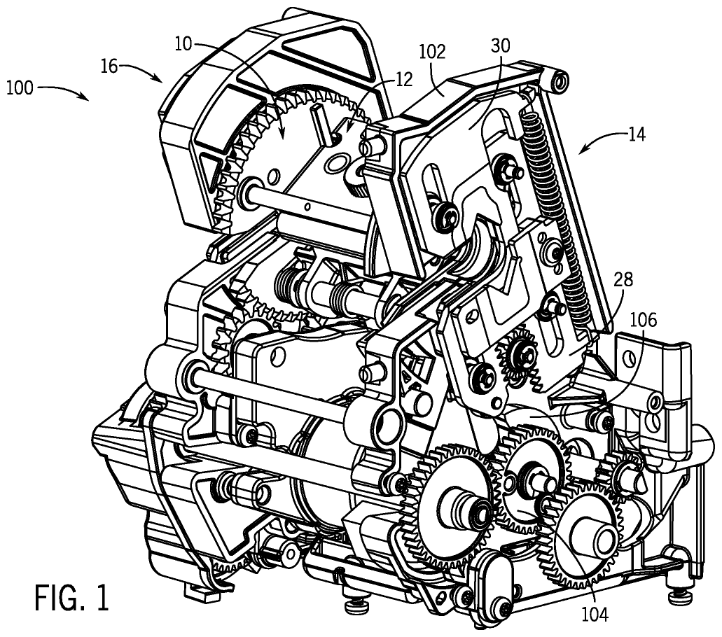

FIG. 1 illustrates a label wrapper mechanism 100 in which a label wrapper assembly 10 can be provided. Elements of the label wrapper assembly 10 interact with elements of the rest of the label wrapper mechanism 100, therefore, frequent reference will be made to the label wrapper mechanism 100 throughout the disclosure.

FIGS. 2 and 3 show the label wrapper assembly 10 isolated from the label wrapper mechanism 100 in an open and closed position, respectively. The label wrapper assembly 10 includes a wrapping subassembly 12 and a set of clamp assemblies 14, 16. The wrapping subassembly 12 can have a roller 18, a block 20, and a set of end plates 70, 72 coupled to the roller 18 and the block 20. It should be understood that although the roller 18 is shown as a serrated roller, alternative configurations of the roller 18 are contemplated. Generally, the roller 18 and the block 20 are biased toward each other by a set of torsion springs 64, 66.

An elongate object 68, shown in FIGS. 2 and 3 as a wire, can be received between the roller 18 and the block 20 as illustrated in FIG. 2 along a wrapping subassembly axis 24 during label application which is subsequently closed as illustrated in FIG. 3. The label wrapper assembly 10 is configured to receive elongate objects having a diameter in the range of about 0.04 inch to about 0.25 inch.

After closing, and during label application, the wrapping subassembly 12 rotates around the elongate object 68 to apply the label. The set of clamp assemblies 14, 16, which hold the wire or elongate object 68 in place during this operation, are shown in FIGS. 2 and 3 axially spaced apart along the wrapping assembly axis 24 on both sides of the wrapping subassembly 12.

The wrapping subassembly 12 may further include a flexible sheet or tarp 26 that can serve as a low-friction surface onto which the label may be placed. The tarp 26 can be wrapped at least partially around the block 20 and can reduce friction between the block 20 and the elongate object 68 when the label wrapper assembly 10 is linearly and/or rotationally moving relative to the elongate object 68, which may improve the adhesion quality of the label. Additionally, the tarp 26 may protect the block 20 from wear and tear and the buildup of adhesive.

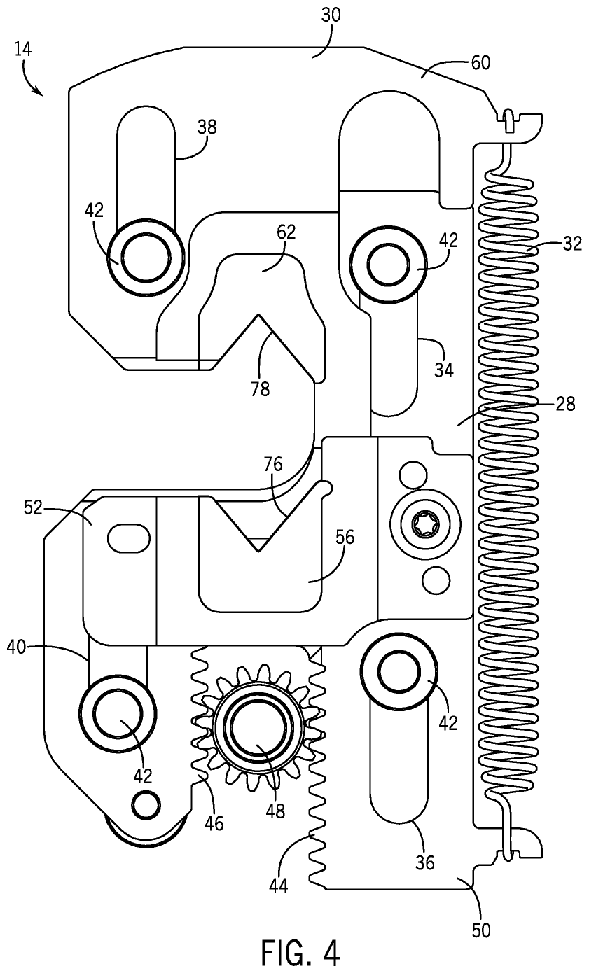

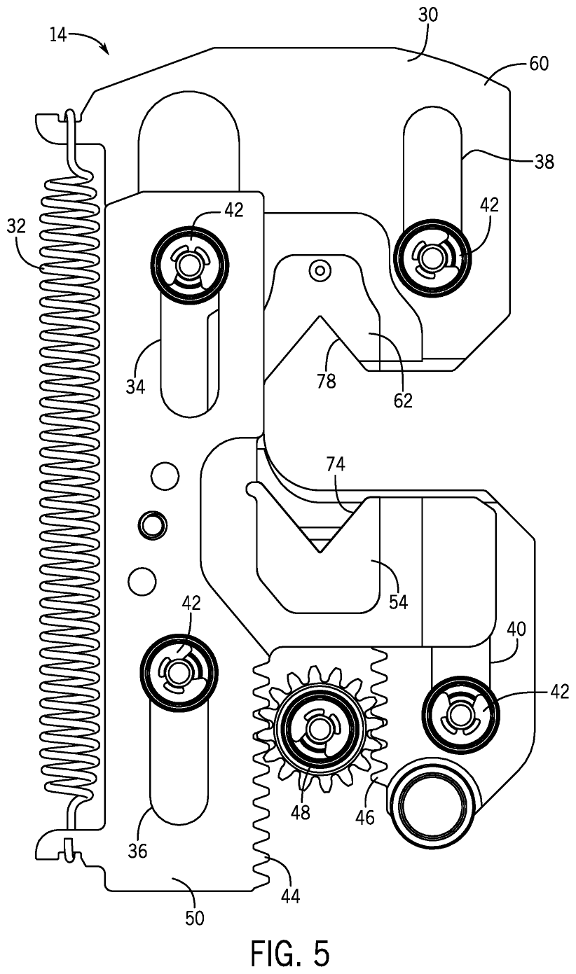

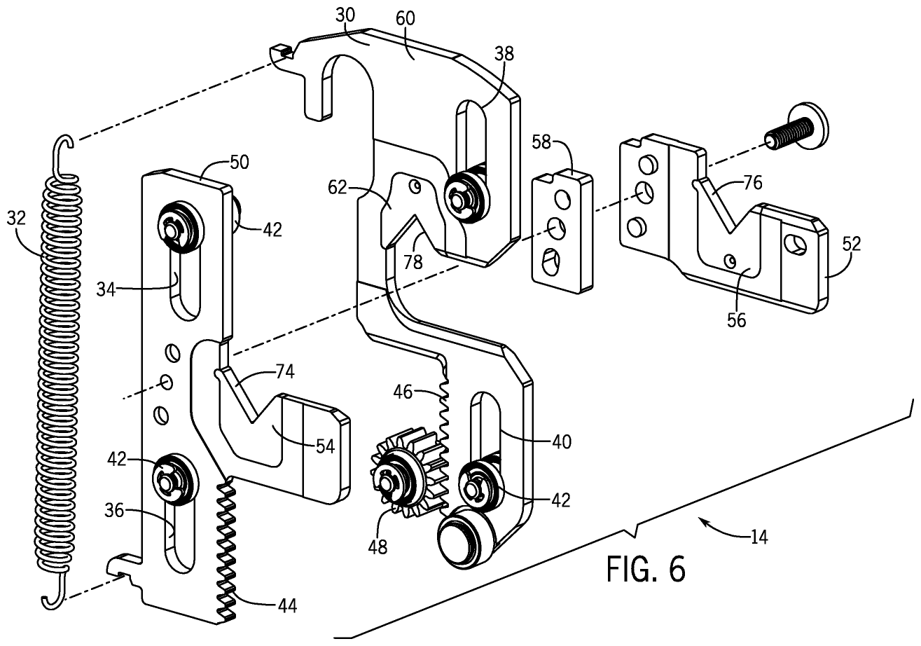

Looking at FIGS. 4-6, the clamp assembly 14 is shown isolated from the rest of the assembly for further illustration and description. It should be understood that clamp assemblies 14, 16 are for the most part substantially the same to one another, and discussion is limited to only one for the sake of clarity and brevity.

The clamp assembly 14 can have a set of clamp members 28, 30 that are slidably movable relative to each other between an open position (FIG. 2) and a clamping position (FIG. 3). In the example embodiment shown in FIGS. 2 and 3, each of the clamp assemblies 14, 16 has a set of clamp members 28, 30, designated (where visible) with an “A” or “B” following the part number 28 or 30. Unless a particular clamp member is specifically being described, the clamp members will be discussed below using only their respective part number 28, 30. The “A” and “B” designation also applies to respective elements within the clamp members 28, 30.

As illustrated, the set of clamp members 28, 30 are biased toward the clamping position (FIG. 3) by a biasing member 32. The biasing member 32 can be a coil spring coupled at one end to the clamp member 28 and at the other end to the clamp member 30; however, other biasing apparatus are contemplated. In some embodiments, the biasing member 32 can impart a clamping force of 2.5 lbs (11.12N) or less to the elongate object 68 when the set of clamp members 28, 30 are in the clamping position. In some embodiments, the clamping force is in the range of 1.5 lbs (6.67N) for smaller wires (e.g., those around 0.04 inches in diameter) to about 2.5 lbs (11.12N) for larger wires (e.g., those around 0.25 inches in diameter).

It should be appreciated that while a biasing member is illustrated in the figures as applying a clamping force, that a clamping force could be applied in other ways not involving a biasing force. For example, a separate hydraulic force could be used to actuate the parts of the clamp members by operation of a control or use of a sensor. Likewise, a mechanical or electromechanical element could be similar controlled whether in way that creates a bias or which is simply actuatable.

As stated above, the set of clamp members 28, 30 can be slidably movable relative to each other. The clamp member 28 can have slots 34, 36 and the clamp member 30 can have slots 38, 40. The slots 34, 36, 38, 40 can be configured to receive a set of bearings 42 or posts coupled to a structural member 102 of the label wrapper mechanism 100 that is coupled to the wrapping subassembly 12. The relationship between the slots 34, 36, 38, 40 and the bearings 42 permit the clamp members 28, 30 to slidably move in a linear direction relative to each other and the wrapping subassembly 12.

A rack and pinion arrangement can be provided to aid in moving the set of clamp members 28, 30 from the clamping position to the open position. Either or both clamp members 28, 30 can have a rack portion 44, 46 operably engageable with a pinion 48. The pinion 48 can be rotated to translate along the rack portions 44, 46 and move the clamp members 28, 30 in opposite directions toward and to the open position. For example, as shown in FIG. 1, a gear 104 with a lobe portion 106 driven by a motor can be operably engageable with a portion the clamp member 30 to move the clamp member 30 relative to the wrapper subassembly 12. The movement of the clamp member 30 rotates the pinion 48 and moves the clamp member 28 in the opposite direction.

It is further contemplated that clamp member 28 can be an assembly with a pair of lower clamp members 50, 52 coupled together with a spacer 58 provided therebetween. Each of the lower clamp members 50, 52 can have a retention element 54, 56. The retention elements 54, 56 can have a notch 74, 76 therein to receive the elongate object 68. The notches 74, 76 are shown having a V-shape profile. The V-shape profile can aid in centering the elongate object 68 when clamping. Other profiles for the notches 74, 76, such as a semi-circular profile or an arcuate profile for example, are also contemplated. In some embodiments, the retention elements 54, 56 can be overmolded portions of the lower clamp members 50, 52. In other embodiments, the retention elements 54, 56 can be inserts coupled to the lower clamp members 50, 52. In some embodiments, the retention elements 54, 56 can be formed from polyurethane. In other embodiments, the retention elements 54, 56 can be formed from rubber.

Clamp member 30 can have an upper clamp member 60 with a retention element 62. The clamp member 30 can be located between the lower clamp members 50, 52. The retention element 62 can have a notch 78 therein to receive the elongate object 68. The notch 78 is shown having a V-shape profile. The V-shape profile can aid in centering the elongate object 68 when clamping. Similar to the notches 74, 76 of the retention elements 54, 56 of the clamp member 28, other profiles for the notch 78, such as a semi-circular profile or an arcuate profile for example, are also contemplated. Further, the retention element 62 of the clamp member 30 can be an overmolded portion of the upper clamp member 60 or an insert coupled to the upper clamp member 60. Moreover, the retention element 62 can be formed from polyurethane or rubber.

It is further contemplated that the notches 74, 76, 78 can each have a differently shaped profile or a combination thereof. For example, in an embodiment of the label wrapper assembly, the notches 74, 76 of the retention elements 54, 56 can have a similarly shaped profile and the notch 78 of the retention element 62 can have a profile shape that is different than the notches 74, 76.

A method of retaining an elongate object within the label wrapper assembly 10 is also contemplated. The method can include opening the set of clamping assemblies 14, 16; aligning the elongate object 68 within the set of clamp members 28A, 28B, 30A, 30B; and clamping the elongate object 68 within the set of clamp members 28A, 28B, 30A, 30B, more specifically between retention elements 54A, 54B, 56A, 56B, 62A, 62B. A clamping force is applied, for example, by the biasing members 32A, 32B to the elongate object 68 at each clamping assembly 14, 16. The clamping force applied can be in the range of about 1.5 lbs (6.67N) to about 2.5 lbs (11.12N). The retention elements 54A, 54B, 56A, 56B, 62A, 62B can absorb at least some of the clamping force through deformation when contacting the elongate object 68. After retention of the elongate object 68 is achieved, the wrapping subassembly 12 can rotate about the elongate object 68 to adhere a label thereto.

The method can also include tensioning the elongate object within the set of clamping assemblies 14, 16. Tensioning can be achieved by moving or rotating one of the clamping assemblies 14, 16 away from the wrapping subassembly 12.

Thus, systems and methods including a label wrapper assembly configured to adhere a label to an elongate object are disclosed herein. The label wrapper assembly can be used to efficiently and repeatability attach a label to an elongate object, for example a wire or fiber optic cable without slippage of the object and or damaging the surface of the object. Accordingly, the label wrapper assembly can retain an elongate object and uniformly press a label against the elongate object to minimize bubbles and ensure that opposing sides of the label are generally aligned with one another.

As noted above, it should be appreciated that various other modifications and variations to the preferred embodiments can be made within the spirit and scope of the invention. Therefore, the invention should not be limited to the described embodiments. To ascertain the full scope of the invention, the following claims should be referenced.

1. A label wrapper assembly configured to adhere a label to an elongate object, the label wrapper assembly comprising:
a wrapping subassembly with a wrapping subassembly axis, when applying a label to the elongate object, the wrapping subassembly rotates about the wrapping subassembly axis and around the elongate object; and
a set of clamp assemblies axially spaced apart along the wrapping subassembly axis on both sides of the wrapping subassembly in which each of the clamp assemblies have a set of clamp members slidably movable relative to each other between an open position and a clamping position, the clamp members providing a clamping force in the clamping position;
wherein each of the clamp members have a retention element with a notch, the retention elements retain the elongate object therebetween when in the clamping position, the retention elements being elastomeric.

2. The label wrapper assembly of claim 1, wherein the notches have a V-shape profile.

3. The label wrapper assembly of claim 1, wherein the retention elements comprise polyurethane.

4. The label wrapper assembly of claim 1, wherein the retention elements are overmolded portions of the clamp members.

5. The label wrapper assembly of claim 1, wherein the retention elements are inserts coupled to the clamp members.

6. The label wrapper assembly of claim 1, wherein the elongate object has a diameter in the range of about 0.04 inch to about 0.25 inch.

7. The label wrapper assembly of claim 1, wherein each clamp assembly is configured to apply a clamping force of about 2.5 lbs or less to the elongate object when in the clamping position.

8. The label wrapper assembly of claim 1, wherein the set of clamp members includes a pair of lower clamp members coupled together and an upper clamp member positioned between the pair of lower clamp members.

9. The label wrapper assembly of claim 8, wherein the clamp assemblies are operated between the open position and the clamping position by a rack and pinion arrangement, wherein at least one of the pair of lower clamp members has a lower clamp member rack, the upper clamp member has an upper clamp member rack, and a pinion is operably engaged with both the lower clamp member rack and the upper clamp member rack to drive the pair of lower clamp members and the upper clamp member in opposite directions.

10. The label wrapper assembly of claim 1 further comprising a structural member with bearings, wherein the clamp members have slots in which the bearings are received, and the clamp members are able to move linearly relative to the wrapping subassembly along the bearings.

11. The label wrapper assembly of claim 1, wherein the set of clamp members are biased toward the clamping position by a biasing member, the biasing member coupled at one end to one of the clamp members and at the other end to the other clamp member.

12. A method of retaining an elongate object within the label wrapper assembly of claim 1, the method comprising:
opening the set of clamping assemblies; and
clamping the elongate object between opposing retention elements of the clamping assemblies.

13. The method of claim 12, wherein the clamping force is in the range of about 1.5 lbs to about 2.5 lbs.

14. The method of claim 12 further comprising:
tensioning the elongate object within the set of clamping assemblies.

15. The method of claim 12, wherein the method further comprises aligning the elongate object along the wrapping subassembly axis.

16. The method of claim 12, wherein at least some of the clamping force is absorbed by the retention elements through deformation when contacting the elongate member.

17. The method of claim 12, wherein the retention elements comprise polyurethane.

18. The method of claim 12, wherein the retention elements are overmolded portions of the set of clamp members.

19. The method of claim 12, wherein the retention elements are inserts coupled to the clamp members.

20. The method of claim 12, wherein the retention elements have notches with a V-shape profile.
